(19) United States
(12) Patent Application Publication
(10) Pub. No.: US 2014/0270660 A1
(43) Pub. Date: Sep. 18, 2014

(54) CONNECTOR WITH ELECTRICAL MODE AND OPTICAL MODE

(71) Applicant: HON HAI PRECISION INDUSTRY CO., LTD., New Taipei (TW)

(72) Inventor: YI-ZHONG SHEU, New Taipei (TW)

(21) Appl. No.: 13/945,907

(22) Filed: Jul. 19, 2013

(30) Foreign Application Priority Data
Mar. 15, 2013 (TW) 102109144

(51) Int. Cl. G02B 6/42

(52) U.S. Cl. CPC G02B 6/4293
USPC 385/93

(57) ABSTRACT

A connector with electrical mode and optical mode includes a housing. The housing includes an end surface and defines a receiving space, and the end surface defines a groove. The connector includes a planar light wave circuit (PLC) splitter, an optical-electrical converting unit, and an optical waveguide all received in the receiving space. The connector includes a collimating lens and an electrical terminal both received in the groove. The PLC splitter includes two branches. One of the branches is connected to the optical waveguide. The optical waveguide is optically coupled to the collimating lens. The other of the branches is optically connected to the optical-electrical converting unit. The optical-electrical converting unit is electrically connected to the electrical terminal.

### BACKGROUND

1. Technical Field

The present disclosure relates to a connector with electrical mode and optical mode.

2. Description of Related Art

An electrical connector can only transmit electrical signals, and an optical connector can only transmit optical signals. The electrical connector is incompatible with the optical connector.

Therefore, it is desirable to provide a connector with electrical mode and optical mode which can overcome the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a connector according to an exemplary embodiment of the present disclosure.

FIG. 2 is a schematic view of the connector of FIG. 1.

### DETAILED DESCRIPTION

FIGS. 1 and 2 show a connector 100 according to an exemplary embodiment. The connector 100 includes a housing 10, optical fibers 60, 61, reflecting lenses 70, 71, planar light wave circuit splitters (PLC splitters) 20, 21, an optical-electrical converting unit 27, optical waveguides 23, 25, collimating lenses 40, 41, and electrical terminals 50. In this embodiment, the electrical terminals 50 are gold fingers. The optical-electrical converting unit 27 includes a photo diode (PD) 30, a laser diode (LD) 31, an amplifier 80, a laser driver 81 and a protocol integrated circuit (protocol IC) 83.

The housing 10 includes a first end surface 11 and a second end surface 13 opposite to the first end surface 11. The housing 10 defines a receiving space 15. The reflecting lenses 70, 71, the PLC splitters 20, 21, the optical-electrical converting unit 27, and the optical waveguides 23, 25 are received in the receiving space 15. The second end surface 13 defines a groove 17. The collimating lenses 40, 41 and the electrical terminals 50 are received in the groove 17.

One end of the optical fiber 60 is aligned with the reflecting lens 70. The PLC splitter 20 includes a trunk 201 aligned with the reflecting lens 70 and two branches 202. One of the branches 202 is optically coupled to the collimating lens 40 via the optical waveguide 23. The other one of the branches 202 is optically coupled to the PD 30. The PD 30, the amplifier 80, the protocol IC 83, and one of the electrical terminals 50 are connected in series.

A first optical signal input by the optical fiber 60 is reflected by the reflecting lens 70 to the PLC splitter 20. The PLC splitter 20 splits the first optical signal into two second optical signals. One of the second optical signals is transmitted by the optical waveguide 23, and is output from the collimating lens 40. The other one of the second optical signals is received by the PD 30. The PD 30 converts the other one of the second optical signals into a first electrical signal. The first electrical signal is transmitted by the amplifier 80, the protocol IC 83, and is output from the electrical terminal 50.

One end of the optical fiber 61 is aligned with the reflecting lens 71. The PLC splitter 21 includes a trunk 211 aligned with the reflecting lens 71 and two branches 212. One of the branches 212 is optically coupled to the collimating lens 41 via the optical waveguide 25. The other one of the branches 212 is optically coupled to the LD 31. The LD 31, the laser driver 81, the protocol IC 83, and one of the electrical terminals 50 are connected in series.

A third optical signal input from the collimating lens 41 is transmitted to the PLC splitter 21 through the optical waveguide 25. The PLC splitter 21 transmits the third optical signal to the reflecting lens 71. The reflecting lens 71 reflects the third optical signal to the optical fiber 61. The third optical signal is output from the optical fiber 61.

A second electrical signal input from the electrical terminal 50 is transmitted to the LD 31 through the protocol IC 83 and the laser driver 81. The LD 31 converts the second electrical signal into a fourth optical signal. The fourth optical signal is transmitted to the PLC splitter 21. The PLC splitter 21 transmits the fourth optical signal to the reflecting lens 71. The reflecting lens 71 reflects the fourth optical signal to the optical fiber 61. The fourth optical signal is output from the optical fiber 61.

The connector 100 can transmit optical signals and electrical signals at the same time. Thus, the connector 100 is compatible with a conventional electrical connector and a conventional optical connector.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A connector comprising:
a housing comprising an end surface and defining a receiving space, the end surface defining a groove;
a planar light wave circuit (PLC) splitter, an optical-electrical converting unit, and an optical waveguide all received in the receiving space; and
a collimating lens and an electrical terminal received in the groove; wherein
the PLC splitter comprises two branches, one of the branches is connected to the optical waveguide, the optical waveguide is optically coupled to the collimating lens, the other of the branches is optically connected to the optical-electrical converting unit, and the optical-electrical converting unit is electrically connected to the electrical terminal.

2. The connector of claim 1, wherein the PLC splitter comprises a trunk, and the connector comprises an optical fiber optically coupled to the trunk.

3. The connector of claim 2, comprising a reflecting lens for reflecting a first optical signal from the optical fiber to the trunk and for reflecting a second optical signal from the trunk to the optical fiber.

4. The connector of claim 1, wherein the optical-electrical converting unit comprises a photo diode, an amplifier, and a protocol integrated circuit connected in series.

5. The connector of claim 1, wherein the optical-electrical converting unit comprises a laser diode, a laser driver, and a protocol integrated circuit connected in series.

6. The connector of claim 1, wherein the electrical terminal is a gold finger.
